(19) United States
(12) Patent Application Publication
(10) Pub. No.: US 2005/0084428 A1
(43) Pub. Date: Apr. 21, 2005

(54) Method of generation ozone, ozone generator, feed gas for ozone generation, and humidifier

(76) Inventors: Shigekazu Tokutake, Amagasaki-shi (JP); Yuji Terashima, Amagasaki-shi (JP); Hiroshi Orishima, Amagasaki-shi (JP)

Correspondence Address: DARBY & DARBY P.C., P. O. BOX 5257, NEW YORK, NY, 10150-5257, US

(21) Appl. No.: 10/500,343

(22) PCT Filed: Dec. 27, 2001
(86) PCT No.: PCT/JP01/11606

(51) Int. Cl. B01J 19/08; B01F 3/04

(52) U.S. Cl. 422/186.07; 261/121.1

(57) ABSTRACT

Oxygen gas having a high purity is supplied to an electric discharge type ozonizer to generate ozone. An ozone density is prevented from decreasing without the use of nitrogen gas by adding moisture to the high-purity oxygen gas via a humidifier when the high-purity oxygen gas is supplied to an ozonizer from an oxygen gas source. Through the addition, the moisture volume in the high-purity oxygen gas supplied to the ozonizer is adjusted to be within the range of 0.05-40 ppm.

### FIELD OF THE INVENTION

The present invention relates to an ozone generation method and an ozone generation apparatus by means of electric discharge, and source gas for ozone generation and a humidifier.

### BACKGROUND TECHNOLOGY

The manufacturing process of a semiconductor began to employ ozone gas for the formation of an oxide film on a wide variety of substrates such as a semiconductor wafer and glass substrate for crystal liquid, ashing of a resist on a substrate, cleaning of a substrate, and the like. Because the manufacturing of the semiconductor requires the ozone gas having a fewer impurities, the ozone gas used therein is usually generated by supplying an ozonizer of a discharge-type with the oxygen gas having a high purity as source gas. The generated ozone gas for the semiconductor manufacture is transported to any section where the gas is used through a pipe made of stainless steel such as SUS316L or fluororesin such as PFA so that the gas is not contaminated.

However, when the oxygen gas of a high purity is used as the source gas, an ozone density of the ozone gas decreases over time from the time when the ozone is first generated, which results in a stable ozone density much lower than an initial ozone density and further causes the problem that even the stable ozone density is destabilized. As a measure for solving the problem, a small amount of catalyzer gas is added to the oxygen gas of a high purity. As the catalyzer gas, nitrogen gas having a high purity, which is easily accessible and inexpensive, is often used in the manufacturing process of the semiconductor.

The nitrogen gas having a high purity is added to the oxygen gas having a high purity as the source gas to thereby effectively control the decrease of the ozone density of the generated ozone gas and further generate the ozone gas having a stable density, whereas metal impurities are unfavorably detected in the ozone gas where the gas is supplied. This allegedly happens because the nitrogen gas included in the oxygen gas generates nitrogen oxides, which is a side product thereof, in the ozone gas, and the nitrogen oxides deteriorate or corrode inner surfaces of the pipe and chamber made of metal resulting in the generation of the metal impurities in the inner surfaces of the pipe and chamber. It is needless to say that such metal impurities exert an adverse effect on the semiconductor manufacture.

As an additional problem, it has been noted recently that the semiconductor manufacture not only suffers from the metal impurities secondarily generated in the inner surfaces of the pipe and chamber made of metal, but also undergoes a direct adverse affect from the nitrogen oxides in the ozone gas.

The ozone gas after being used in the manufacturing process needs to be dissolved into the oxygen gas to be finally exhausted. When the catalyzer is used in the dissolution, the nitrogen oxides are poison to the catalyzer, therefore constitutes a reason for shortening a life of the catalyzer.

A main object of the present invention is to provide an ozone generation method, ozone generation apparatus, source gas for ozone generation, and humidifier capable of controlling the decrease of the ozone density and stabilizing the density without generating hazardous materials such as the nitrogen oxides.

### DESCRIPTION OF THE INVENTION

The inventors of the present invention, who have been continuing their research and study for a higher density of ozone gas, investigated adverse affects caused by temperatures of source gas with respect to an ozone density as a part of their work, and incidentally came across the phenomenon that serial decreases of the ozone density dramatically dropped. As they looked into the cause of the phenomenon, they found out that the decrease of the ozone density over time was effectively controlled by a small volume of moisture of approximately 0.1-10 ppm invaded into oxygen gas having a high purity distributed in a resin-made source gas pipe dipped in warm water through a wall thereof in order to adjust the temperature of the source gas, and the moisture in the oxygen gas can be quite an advantageous catalyzer material replacing nitrogen gas.

More specifically, the effect of controlling the decrease of the ozone density by means of the moisture is achievable with the moisture in a very small volume of only approximately 0.1-10 ppm, and does not entail any substantial decrease of an oxygen density. For example, the effect obtained by means of the moisture of 1 ppm equals to the effect obtained by means of the nitrogen gas of 1000-10000 ppm. The moisture is innocuous itself, and further does not generate any hazardous side product such as the nitrogen oxides and a small volume thereof can advantageously exert an effect. Because of the advantages, the use of the moisture does not cause any problem in the field of semiconductor manufacturing.

The present invention has been completed based on the foregoing findings, and relates to an ozone generation method, wherein an ozonizer of an electric-discharge type is supplied with the oxygen gas including the moisture of 0.05-40 ppm as the source gas for ozone generation. The present invention further relates to an ozone generation method, wherein the moisture is added to the oxygen gas when the oxygen gas is supplied to the discharge-type ozonizer as the source gas for ozone generation. An ozone generation apparatus according to the present invention comprises the discharge-type ozonizer, a gas supply system for supplying the ozonizer with the source gas, a moisture adjusting device, which is interposed in the gas supply system and adjusts the moisture volume in the source gas. The present invention further relates to source gas for ozone generation made of the oxygen including the moisture of 0.05-40 ppm. The present invention further relates to a humidifier for adding the moisture to the oxygen gas supplied to the discharge-type ozonizer as the source gas for ozone generation, comprising a water tank containing pure water, and a resin tube, which is dipped in the pure water in the water tank and distributes the oxygen gas inside thereof. The present invention further relates to a humidifier comprising a tube assembly comprised of a plurality of resin tubes bound together and a vessel for containing the pure water together with the tube assembly.

The oxygen gas used in the field of semiconductor manufacturing as the source gas for ozone generation is generally the oxygen gas having a high purity of 99.99% or above, and supplied to the ozonizer using liquid oxygen or oxygen gas contained in a gas cylinder as an oxygen gas source. Of all the impurities, the moisture in the oxygen gas can be relatively easily eliminated, and mostly eliminated in a refining process for eliminating the impurities. Because of the concern that the moisture can possibly adversely affect on an ozone yield, the moisture volume included in the oxygen gas is 0.01 ppm or below in the case of the purity being 99.99%, and 0.001 ppm or below in the case of the purity being 99.9999%.

The moisture volume included in the oxygen gas to be supplied to the ozonizer is set at 0.05-40 ppm because the moisture of less than 0.05 ppm cannot control the decrease of the ozone density effectively enough, and the moisture exceeding 40 ppm lowers an efficiency of the ozone generation to thereby cause the ozone density to start to fall again and further unfavorably exerts an adverse affect on a discharge unit of the ozonizer and down-stream-side process. A preferable lower limit is 0.1 ppm, and more desirably 0.5 ppm. A preferable upper limit is 10 ppm, and more desirably 3 ppm.

The oxygen gas is supplied to the ozonizer from the oxygen gas source through the gas supply system. When there is a shortage of the moisture included in the oxygen gas in the oxygen gas source, it is preferable that a predetermined volume of moisture be added to the oxygen gas by the humidifier at an intermediate position in the gas supply system to thereby supply the ozonizer with the moisture-added oxygen. However, it is possible to supply the ozonizer with the oxygen gas with the predetermined volume of moisture previously added thereto from the oxygen gas source. When the oxygen gas hypothetically includes an excessive volume of moisture in the oxygen gas source, it is preferable that the moisture be diminished by the dehumidifier so that the moisture volume in the oxygen gas is controlled to stay within a predetermined range at the intermediate position in the gas supply system to thereby supply the ozonizer with the moisture-diminished oxygen gas.

The oxygen gas used, that is the oxygen gas prior to the moisture adjustment, preferably has a high purity of 99.9% or above, more desirably a high purity of 99.99% or above, and most desirably a super-high purity of 99.9999% or above, because not only the oxygen gas having a higher purity enables the elimination of the impurities but also the control of the decrease of the ozone density using the moisture in a small volume is more effective as the oxygen gas has a higher purity. More specifically, the moisture in the oxygen gas reacts to the oxygen and impurities therein, and the moisture is eventually consumed in a large volume in order to react to the impurities, which interferes with the reaction between the moisture and oxygen (ozone generation reaction). In the oxygen gas of a higher purity and therefore a fewer impurities, the interference can be better controlled.

The ozone density of the ozone gas generated by the ozonizer is preferably 60 g/Nm³ or above, more desirably 100 g/Nm³or above, and most desirably 150 g/Nm³, because a higher density improves the reactivity, and further, the control of the decrease of the ozone density using a small volume of moisture is more effective as the ozone gas has a higher density. More specifically, as the ozone density becomes higher, the dissolving reaction accordingly increases. This phenomenon is even more remarkable in the absence of the catalyzer gas, thereby enlarging the decrease of the ozone density. However the moisture prevents the decrease of the ozone density, which is more remarkable with a higher density, in place of the catalyzer gas.

The humidifier can be a type utilizing the before-mentioned resin tube or a type directly adding the moisture to the oxygen gas. The directly adding humidifier has a configuration that the moisture is directly supplied to the oxygen gas distributed through the pipe by means of a micropipet or the like, or a configuration that the oxygen gas is directly distributed into the vessel containing water. In the case of the latter, the oxygen gas can be bubbled in the water in the vessel or can be merely contacted with the water in the vessel. In the case of the bubbling, where the moisture may be excessively added, it is desirable to combine dry oxygen gas having a low dew point with the oxygen gas passing through the water in the vessel so that the moisture volume is adjusted.

The present invention is particularly effective for the oxygen gas having a high purity of 99.99% or above used in the field of semiconductor manufacturing, and is also applicable to the oxygen gas having a purity of approximately 95% used in a general field such as water treatment and the like. The oxygen gas of a relatively low density having a purity of approximately 95% is produced using an oxygen production apparatus such as PSA. The oxygen gas produced by the oxygen production apparatus has a purity of approximately 90-93% and contains a slight volume of nitrogen gas, and the oxygen gas having a purity of approximately 95%, from which the nitrogen gas is eliminated through an absorbent, also loses the moisture together with the nitrogen gas, which results in a lowered ozone density. The ozone density is prevented from decreasing by adjusting the moisture volume in the oxygen gas.

Further, according to the present invention, the oxygen gas includes the impurities other than the moisture, and types of the impurities are not limited. The impurities other than the moisture include argon gas, carbon dioxide gas, nitrogen gas, and the like. More specifically, when the nitrogen oxides do not cause any problem on the down-stream process, the nitrogen gas can be included. When the nitrogen oxides possibly cause any problem, the inclusion thereof by 1000 ppm or below should not lead to any particular problem. The nitrogen gas can complement the effect obtained from controlling the decrease of the ozone density by means of a small volume of moisture. With the nitrogen gas being further included, the oxygen gas having a moisture volume of less than 0.05 ppm can successfully contribute to the control of the decrease of the ozone density.

### BRIEF DESCRIPTION OF THE DRAWINGS

FIG. 1 is a view illustrating a configuration of an ozone generation apparatus according an embodiment of the present invention.

FIG. 2 is a graph showing a relationship between adding rates of nitrogen gas with respect to oxygen gas and stable ozone densities.

FIG. 3 is a graph showing a relationship between volumes of moisture included in oxygen gas and stable ozone densities.

FIG. 4 is a view illustrating a configuration of another humidifier.

FIGS. 5(a)-5(c) are views illustrating a configuration of yet another humidifier.

### A PREFERRED EMBODIMENT OF THE PRESENT INVENTION

Hereinafter, an embodiment of the present invention is described referring to the drawings.

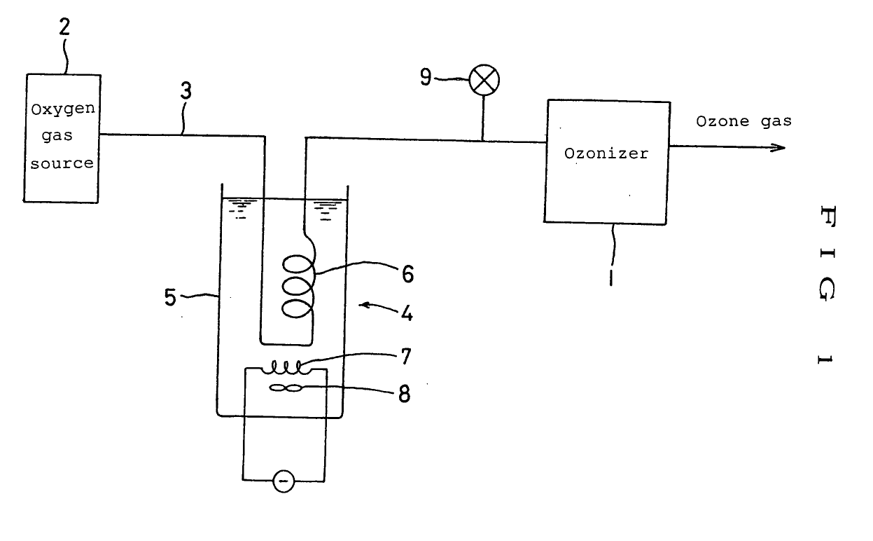

An ozone generation apparatus shown in FIG. 1 comprises an ozonizer 1 of an electric discharge type as a main body of the apparatus. To the ozonizer 1 is supplied, for example, oxygen gas having a high purity from an oxygen gas source 2 through a pipe 3. The oxygen gas source 2 is, for example, liquid oxygen contained in a gas cylinder. A humidifier 4 as a moisture adjusting device is provided at an intermediate position in the pipe 3. The humidifier 4 comprises a water tank 5 containing pure water, a tube 6 having a spiral shape and made of resin having moisture permeability such as Teflon, a heater 7 for controlling a temperature of the pure water in the water tank 5, and an agitator 8 for agitating the pure water in the water tank 5. The tube 6 is interposed at the intermediate position in the pipe 3 and dipped in the pure water in the water tank 5.

The oxygen gas of a high purity as the source gas is supplied to the ozonizer 1 from the oxygen gas source 2 via the humidifier 4. In the humidifier 4, moisture is added to the oxygen gas through a resin wall of the tube 6 as the gas is passing through the tube 6. The added volume is adjusted in compliance with the temperatures of the pure water varied by the heater 7. The adjustment controls the volume of the moisture included in the high-purity oxygen gas supplied to the ozonizer 1 to stay within the range of 0.05-40 ppm, preferably 0.1-10 ppm. In order to implement the control, the moisture volume included in the high-purity oxygen gas is monitored by a dew point recorder 9, which is provided between the humidifier 4 and ozonizer 1.

The actual result of the generation of the ozone gas by means of the described ozone generation apparatus is described below.

The oxygen gas having a super-high purity of 99.9999% or above was used. The moisture volume included in the oxygen gas was −110° C., which was a measurement limit, or below and at the 0.001 ppm level according to the measurement by the dew point recorder. When the super-high-purity oxygen gas was directly supplied to the ozonizer, the ozone density, which marked 150 g/Nm³ or above when the ozone generation started, decreased to 70 g/Nm³.

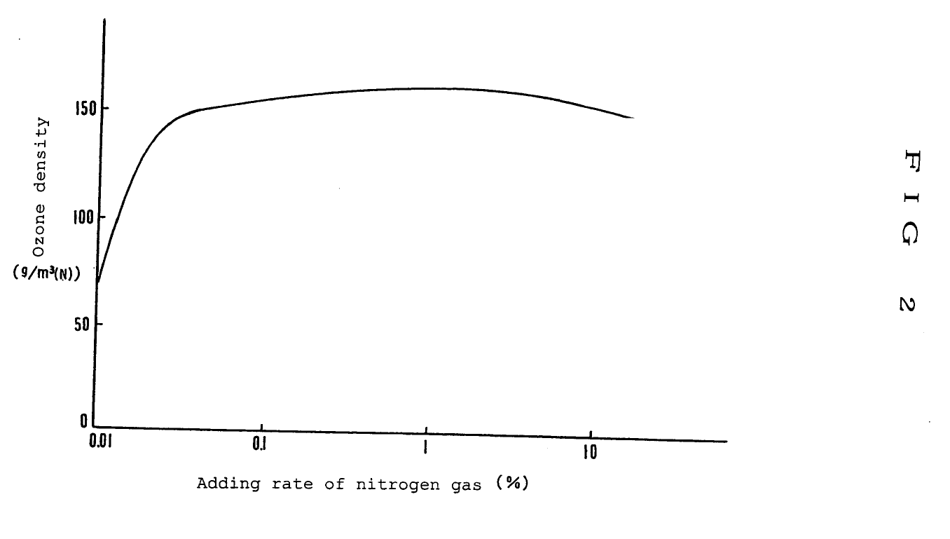

The nitrogen gas having a high purity was added to the super-high-purity oxygen gas. FIG. 2 shows a relationship between adding rates of the nitrogen gas with respect to the oxygen gas and stable ozone densities. When the nitrogen gas is added by 1% (10000 ppm) or above, the stable ozone density is improved to approximately 150 g/Nm³.

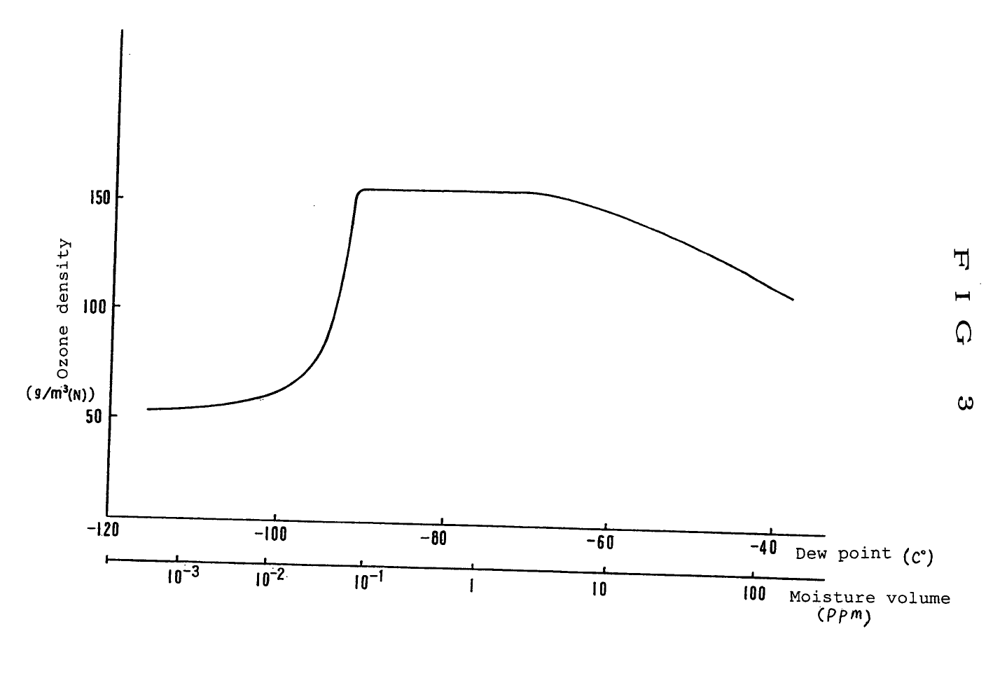

When a small amount of moisture, instead of the nitrogen gas, is added to the super-high-purity oxygen gas by means of the humidifier to thereby increase the moisture volume included in the oxygen gas. FIG. 3 shows a relationship between moisture volumes included in the oxygen gas and stable ozone densities.

As known from FIG. 3, the decrease of the ozone density is controlled, and the ozone gas having a higher density is stably generated when the moisture volume included in the oxygen gas is slightly increased in the same manner as in the case of including the nitrogen gas in a relatively large volume.

In the configuration according to the present embodiment, the moisture is added, in the humidifier 4, to the oxygen gas passing through the tube 6 made of resin having the moisture permeability such as Teflon and dipped in the heated pure water in the water tank 5. However, it is not necessarily the case that the resin tube having the satisfying moisture permeability and warm water must always be used. The resin tube having an inadequate moisture permeability such as PTFE and water at room temperature can also be effectively used when the moisture permeability is improved by thinning a thickness of the tube assembly and enlarging a surface area thereof.

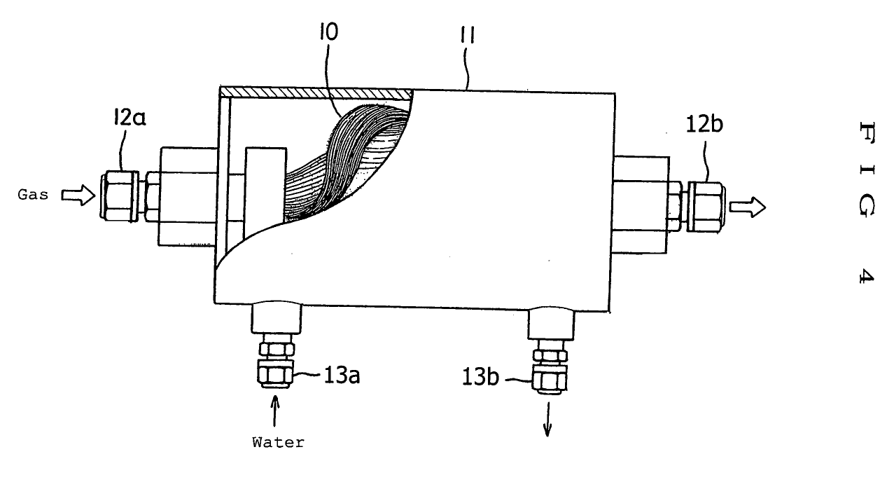

FIG. 4 shows an example of the foregoing humidifier 4. The humidifier 4 shown in FIG. 4 comprises a tube assembly 10 comprised of a multiplicity of thin resin tubes bound together and a cylindrical sealing vessel 11 containing the assembly 10.

The multiple resin tubes forming the tube assembly 10 are, for example, small-diameter and thin PTFE tubes each having an outer diameter of 1 mm and a thickness of 0.1 mm. The tube assembly 10 is formed, for example, from tens of the PTFE tubes, which are bound together. The tube assembly 10 has an entire length of 1500 mm, which is sufficiently long corresponding to an entire length of the vessel 11 that is 200 mm, and a large surface area resulting from the tubes contained in the vessel 11 in a bending and meandering state.

The oxygen gas is distributed through the multiplicity of resin tubes forming the tube assembly 10 through gas heads 12a and 12b provided in end plates of the vessel 11. The pure water of room temperature is distributed into a section in the vessel 11 on an outer side thereof with respect to the tube assembly 10 through water heads 13a and 13b provided in a barrel portion of the vessel 11. In this manner, the moisture is added to the oxygen gas passing through the multiplicity of resin tubes forming the tube assembly 10.

More specifically, as in the case of the humidifier 4 shown in FIG. 4, the thickness of the tube assembly is thinned and the surface area of the tube assembly is increased in compliance with the increased number and length of the tubes so that the resin irrespective of the moisture permeability thereof and water at room temperature can be used.

The moisture volume to be added to the oxygen gas can be adjusted by slightly heating the pure water to be introduced into the vessel 11.

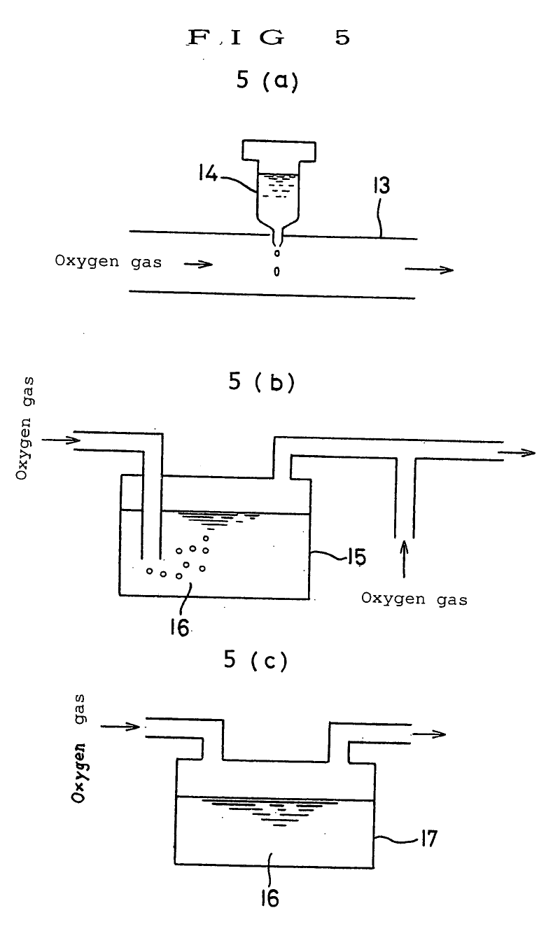

The humidifier 4 shown in FIG. 4 adds the moisture to the oxygen gas through the resin tubes and can directly add the moisture without the resin tubes. FIGS. 5(a), (b) and (c) show humidifiers, which directly adds the moisture.

In the humidifier shown in FIG. 5(a), the moisture in an appropriate volume is directly added to the oxygen gas distributed through a pipe 13 by a micropipet 14. In the humidifier shown in FIG. 5(b), the oxygen gas is bubbled in pure water 16 in a vessel 15 so that the moisture is directly added to the oxygen gas. The oxygen gas of a low dew point is combined with the moisture-added oxygen gas on a down-stream side of the vessel 15 so that the moisture volume thereof is adjusted. In the humidifier shown in FIG. 5(c), the oxygen gas is introduced into a space in a vessel 17 containing the pure water 16, and the introduced oxygen gas contacts with a surface of the pure water 16 in the vessel 17 and the moisture is thereby directly added. The moisture volume can be adjusted by varying the volume of the distributed gas in the space in the vessel 17, the temperature of the pure water 16 in the vessel 17, and the like.

### INDUSTRIAL APPLICABILITY

As thus far described, the ozone generation method, ozone generation apparatus, source gas for ozone generation, and humidifier according to the present invention is capable of controlling the decrease of the ozone density without the use of the nitrogen gas by adjusting the moisture volume included in the oxygen gas supplied to the discharge-type ozonizer and further stabilizing the ozone density, thereby controlling the performance level of the ozonizer and preventing the generation of the nitrogen oxides.

1. An ozone generation method comprising the step of supplying oxygen gas including moisture of 0.05-40 ppm to an electric discharge type ozonizer for ozone generation.

2. An ozone generation method comprising the step of adding moisture to oxygen gas when the oxygen gas is supplied to an electric discharge type ozonizer for ozone generation.

3. The ozone generation method as claimed in claim 2, wherein the moisture is added to the oxygen gas so that the moisture volume in the oxygen gas supplied to the ozonizer is within the range of 0.05-40 ppm.

4. The ozone generation method as claimed in claim 1, wherein the oxygen gas has a purity of at least 99.9%.

5. The ozone generation method as claimed in claim 1 further comprising the step of using ozone gas generated by the ozonizer for manufacturing a semiconductor.

6. The ozone generation method as claimed in claim 1 further comprising the step of generating ozone gas with the ozonizer having a density of at least 60 g/Nm³.

7. An ozone generation apparatus comprising:
an electric discharge type ozonizer;
a gas supply system supplying the ozonizer with a source gas; and
a moisture adjusting device, interposed in the gas supply system, for adjusting a moisture volume in the source gas.

8. The ozone generation apparatus as claimed in claim 7, wherein the moisture adjusting device is a humidifier adding the moisture to the source gas.

9. An ozone generation apparatus as claimed in claim 7 whrein the source gas is oxygen gas having a moisture of 0.05-40 ppm.

10. A humidifier for adding moisture to oxygen gas supplied to an electric discharge type ozonizer as source gas for ozone generation, comprising:
a water tank containing pure water; and
a resin tube dipped in the pure water in the water tank, for distributing the oxygen gas therein.

11. The humidifier as claimed in claim 10, wherein the resin tube has moisture permeability.

12. The humidifier as claimed in claim 10, further comprising a heater controlling a temperature of the pure water in the water tank.

13. The humidifier as claimed in claim 10, further comprising an agitator for agitating the pure water in the water tank.

14. The humidifier for adding moisture to oxygen gas supplied to an electric discharge type ozonizer as source gas for ozone generation, comprising:
a tube assembly comprising a plurality of resin tubes bound together; and
a vessel containing pure water together with the tube assembly.

15. The humidifier as claimed in claim 14, wherein the tube assembly has length longer than a length of the vessel and the tube assembly is contained in the vessel in a bending and meandering state.

16. The humidifier as claimed in claim 14, wherein the vessel is configured to distribute the pure water therein.

17. A humidifier for adding moisture to oxygen gas supplied to an ozonizer of an electric discharge type as source gas for ozone generation, comprising,
a device for adding pure water to the oxygen gas distributed through a pipe.

18. A humidifier for adding moisture to oxygen gas supplied to an electric discharge type ozonizer as source gas for ozone generation, comprising;
a vessel for containing pure water;
a device for distributing the oxygen gas into the pure water or a space in the vessel.

19. The ozone generation method as claimed in claim 2, wherein the oxygen gas has a purity of at least 99.9%.

20. The ozone generation method as claimed in claim 2, further comprising the step of generating ozone gas with the ozonizer having a density of at least 60 g/Nm³.
